(19) United States
(12) Patent Application Publication
(10) Pub. No.: US 2003/0141635 A1
(43) Pub. Date: Jul. 31, 2003

(54) Device and method for making integrally air sac

(76) Inventors: Lee Pao-Hsi, Tsautuen Jen (TW); Yaw Jyh-Liang, Hemei Jen (TW)

Correspondence Address: LAW OFFICE OF LIAUH & ASSOC., 4224 WAIALAE AVE, STE 5-388, HONOLULU, HI, 96816

(21) Appl. No.: 10/058,208

(22) Filed: Jan. 25, 2002

(51) Int. Cl. B29C 44/02

(52) U.S. Cl. 264/516; 425/501; 425/384; 264/545

(57) ABSTRACT

A device comprises a male mold, a male prepress board slidably fastened with the male mold, a female mold, and a female prepress board slidably fastened with the female mold. The device is used to make an air sac in such a way that a cylindrical polyurethane body is first flattened out by the prepress boards, and that a closed air sac body is formed in the slide holes of the prepress boards, and further that the air sac is finally formed in the mold cavities of the male mold and the female mold.

### FIELD OF THE INVENTION

The present invention relates generally to an air sac, and more particularly to a device and a method for making integrally the air sac.

### BACKGROUND OF THE INVENTION

The air sac is widely used as a cushion serving to provide protection against friction, shock, pressure, and the like. The conventional method for making an air sac of polyurethane (PU) involves a blow molding process by which a cylindrical polyurethane body is formed. The cylindrical PU body is then arranged in a molding tool into which air is blown, thereby causing the PU layer to attach to the male mold and the female mold. Upon completion of the cooling process, an air sac 2 is produced, as shown in FIG. 1. The air sac 2 is dressed and provided with an air port 1 via which the air sac 2 is inflated. After the air sac 2 is inflated, the air port 1 is sealed off by a high frequency seal, as illustrated in FIG. 2. Such a prior art method as described above is not cost-effective. In addition, a seal mark is left on the air sac 2. The seal mark undermines the appearance of the air sac 2.

As shown in FIG. 3, another prior art air sac 3 is made in such a way that the air sc 3 contains a filling 4 which is enclosed therein at the time when the air sac 3 is formed. A seal mark 5 is left on the air sac 3. The method for making the air sac 3 is also time-consuming and uneconomical.

### SUMMARY OF THE INVENTION

The primary objective of the present invention is to provide a device and a method for making an air sac at low cost.

It is another objective of the present invention to provide a device and a method for making a high-quality air sac.

In keeping with the principle of the present invention, the foregoing objectives of the present invention is attained by a device comprising a male mold and a female mold, which are provided with one or more mold cores, each having a mold cavity. The male and the female molds are further provided with a movable prepress board, which is in turn provided with a slide hole. Prior to the closing of the molding tool, the prepress boards are first joined together such that the mold cores of the male mold and the female mold are put through the slide holes of the prepress boards.

The method of the present invention involves a first step in which a cylindrical polyurethane body is held by the two prepress boards. The cylindrical polyurethane body is then flattened out by the two prepress boards. Thereafter, a closed air sac body is formed in the slide holes of the prepress boards. Subsequently, the male and the female molds are pressed again such that the mold cores move out of the slide holes, and that the air sac body is pressed against by the mold cavity edges, thereby causing the polyurethane layer to attach to the mold cavities. Upon completion of a cooling process, the molding tool is opened to remove therefrom an air sac, which is finally dressed. The air sac produced by the device and the method of the present invention is devoid of the seal mark and is exempted from the inflating process.

The features and the advantages of the present invention will be more readily understood upon a thoughtful deliberation of the following detailed description of the present invention with reference to the accompanying drawings.

### BRIEF DESCRIPTION OF THE DRAWINGS

FIG. 1 shows a schematic view of an unfinished air sac of the prior art.

FIG. 2 shows a schematic view of a dressed air sac of the prior art as shown in FIG. 1.

FIG. 3 shows a schematic view of another prior art air sac.

FIG. 4 shows an exploded view of the molding tool of the present invention.

FIG. 5 shows a schematic view of the molding tool of the present invention in combination.

FIG. 6 shows a sectional schematic view of the male mold of the present invention.

FIG. 7 shows a schematic view of a material feeding process of the present invention.

FIG. 8 shows a schematic view of a mold closing process of the present invention.

FIG. 9 shows another schematic view of the mold closing process of the present invention.

FIG. 10 shows a schematic view of a freshly-made air sac of the present invention.

FIG. 11 shows a schematic view of a dressed air sac of the present invention.

FIG. 12 shows a schematic view of the mold closing process of another molding tool of the present invention.

FIG. 13 shows another schematic view of the mold closing process of another molding tool of the present invention.

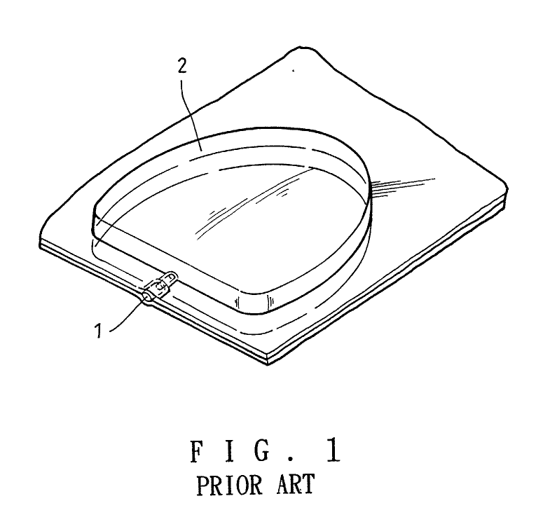

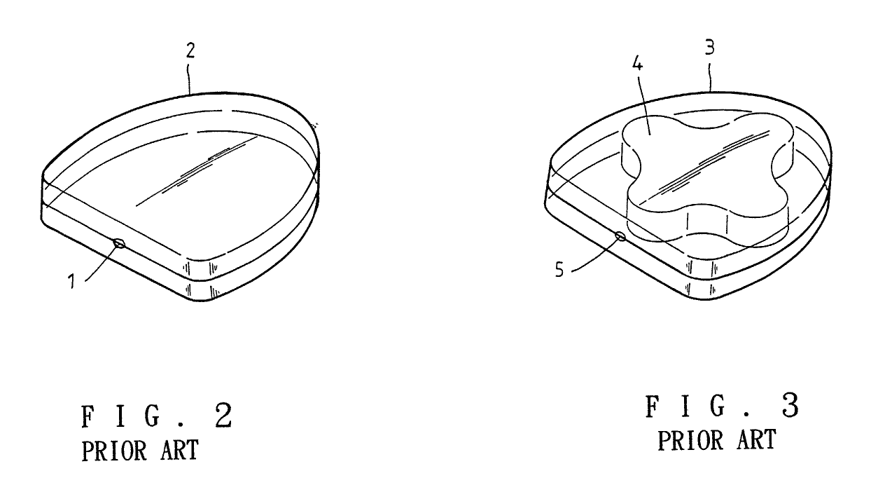

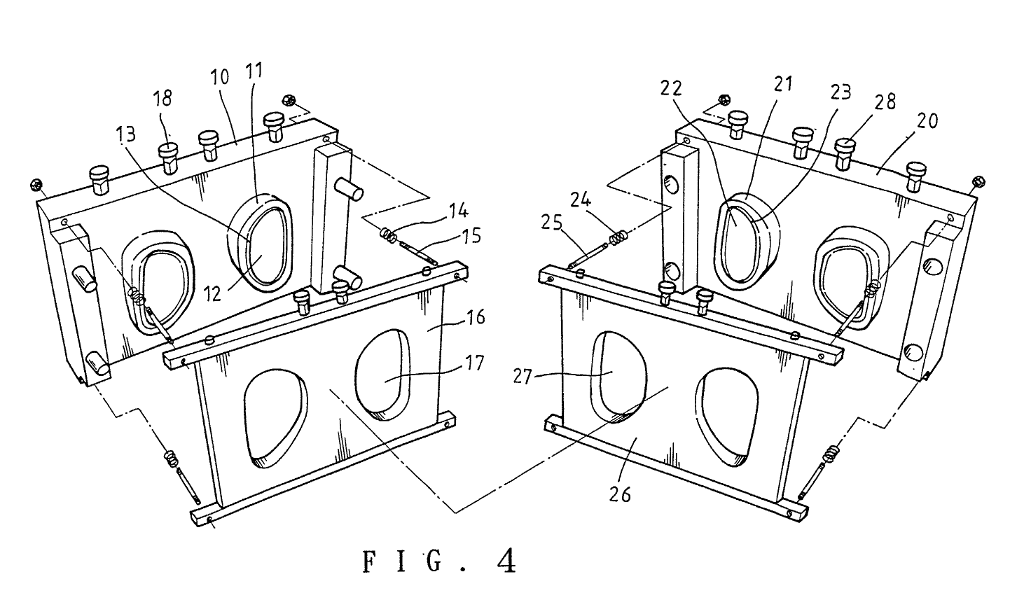

### DETAILED DESCRIPTION OF THE INVENTION

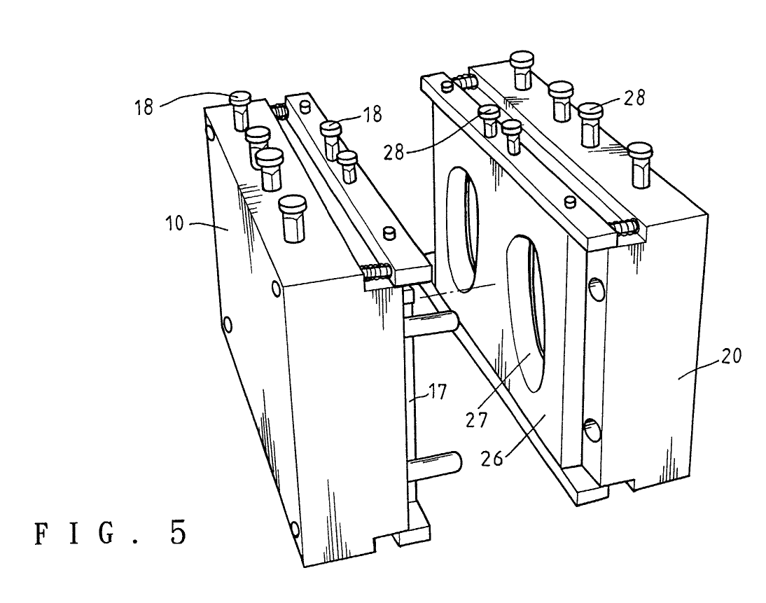

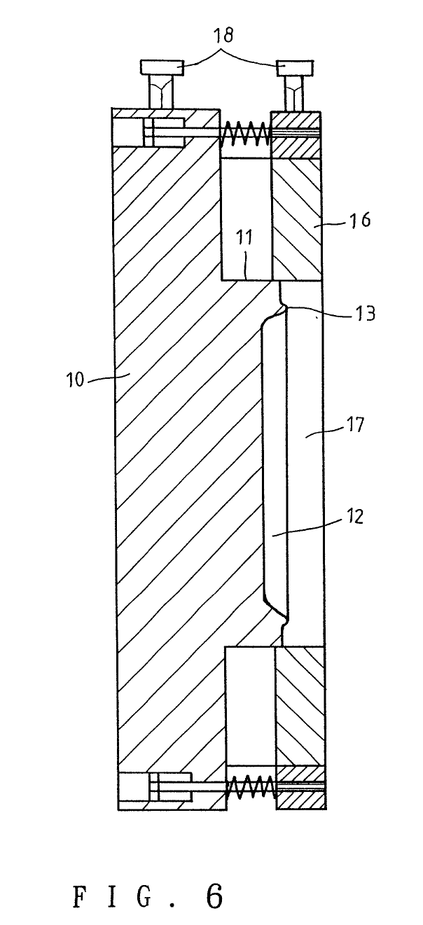

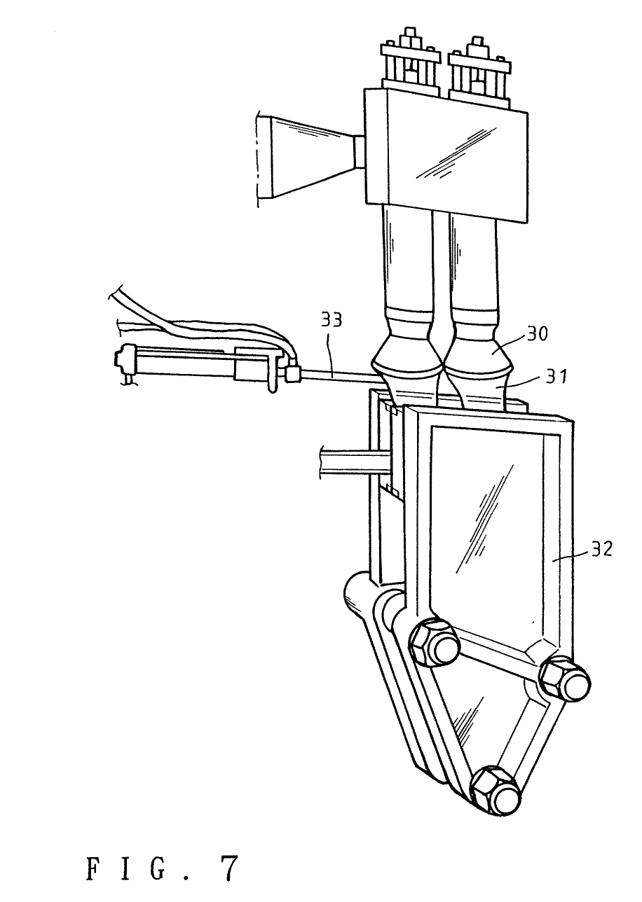

As shown in FIGS. 4, 5, and 6, a device of the present invention comprises a male mold 10 and a female mold 20.

The male mold 10 is provided with a mold core 11, which is in turn provided with a mold cavity 12 having a mold cavity edge 13. The male mold 10 is further provided with a prepress board 16 having a slide hole 17. The prepress board 16 is fastened with the male mold 10 by a plurality of fastening rods 15 and springs 14 which are fitted over the fastening rod 15. The slide hole 17 is corresponding in location and shape to the mold core 11.

The female mold 20 is provided with a mold core 21, which is in turn provided with a mold cavity 22 having a mold cavity edge 23. The female mold 20 is further provided with a prepress board 26 having a slide hole 27. The prepress board 26 is fastened to the female mold 20 by a plurality of fastening rods 25 and springs 24 which are fitted over the fastening rods 25. The slide hole 27 is corresponding in location and shape to the mold core 21. The mold core 21 is corresponding in location and shape to the mold core 11 of the male mold 10.

The male mold 10 and the female mold 20 are joined together such that the mold core 11 of the male mold 10 is put through the slide hole 17 of the prepress board 16, and that the mold core 21 of the female mold 20 is put through the slide hole 27 of the prepress board 26. It must be noted here that the slide hole 17 is slightly greater in size than the mold core 11, and that the slide hole 27 is slightly greater in size that the mold core 21 of the female mold 20.

The male mold 10 and the prepress board 16 are provided with a plurality of cooling water pipes 18. The female mold 20 and the prepress board 26 are provided with a plurality of cooling water pipes 28.

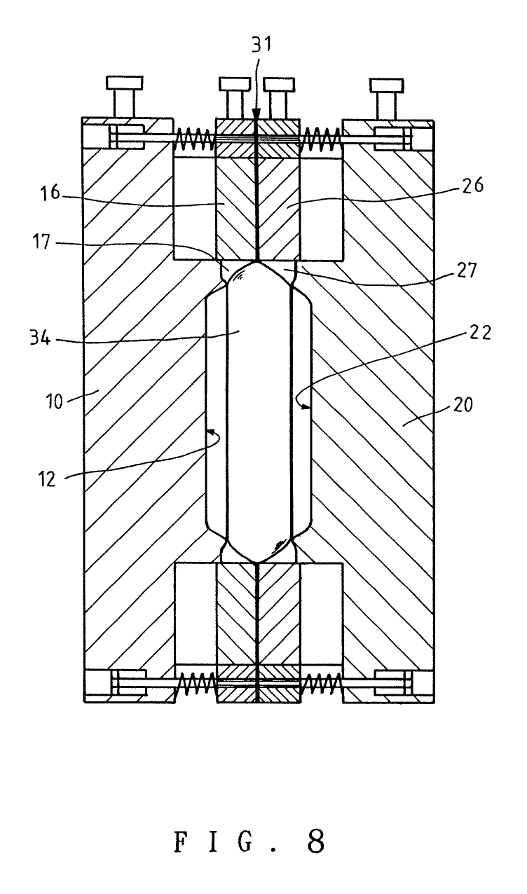

As shown in FIG. 7, a cylindrical polyurethane body 31 is discharged from an outlet 30 of a cylindrical body forming machine. By using a moving device, the device of the present invention is moved to receive the cylindrical polyurethane (PU) body 31. With a thermoelectric device 33, the cylindrical PU body 31 is severed.

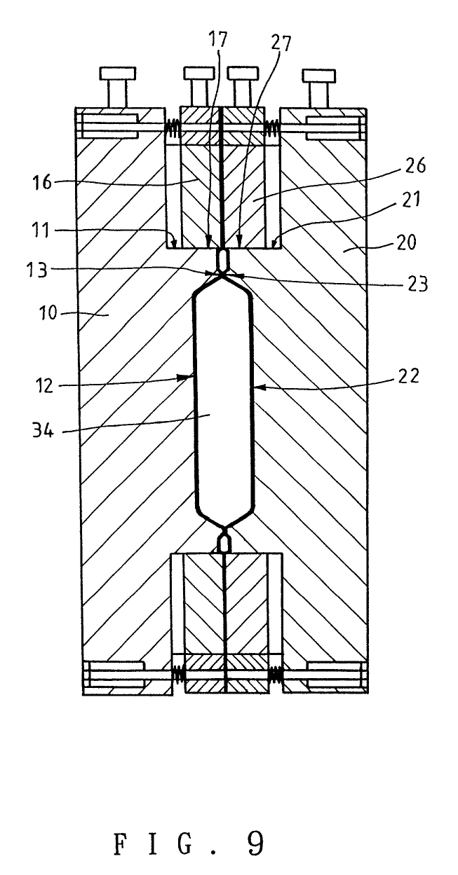

As shown in FIG. 8, the male mold 10 and the female mold 20 are initially joined together such that the PU body 31 is pressed against by the male prepress board 16 and the female prepress board 26, and that the cylindrical PU body 31 is thus flattened out, and further that the PU body 31 located in the slide holes 17 and 27 forms an inflated air sac body 34.

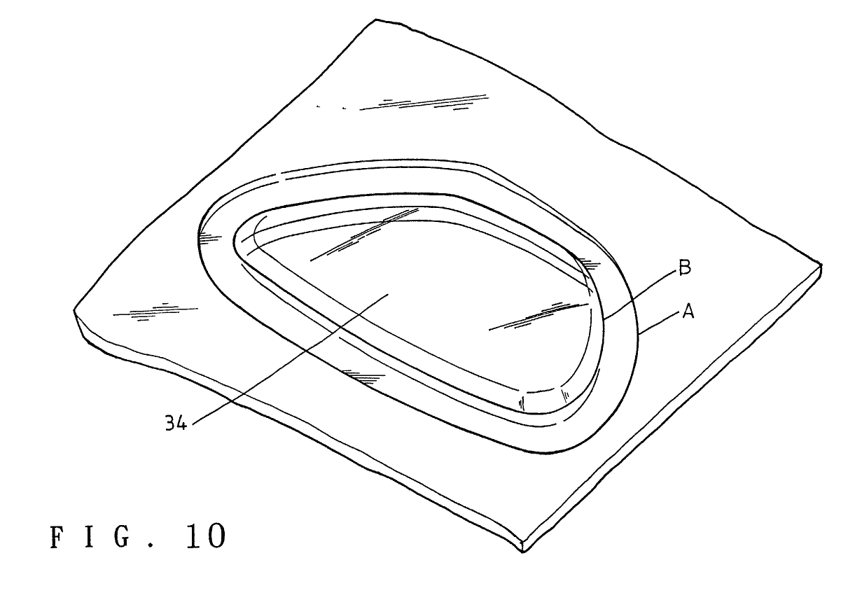

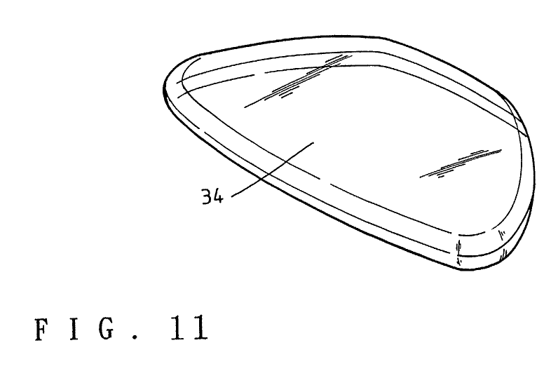

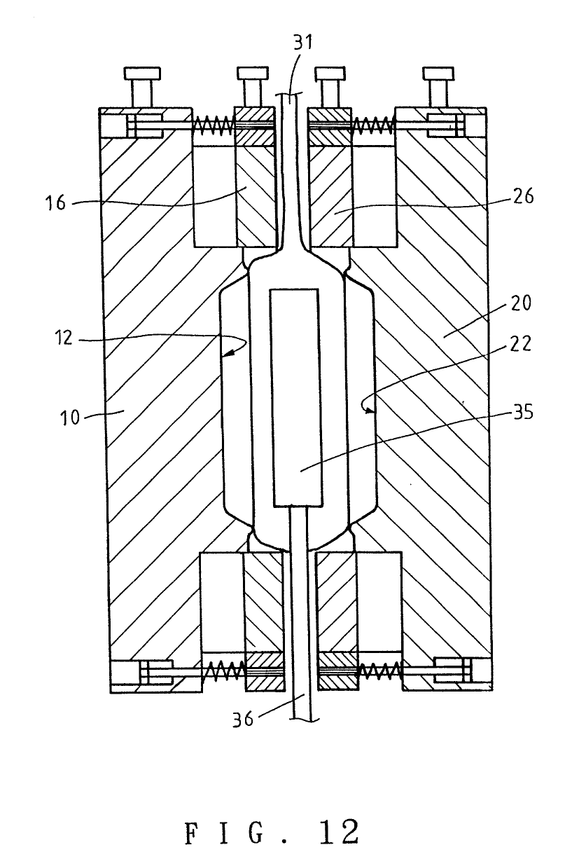

As shown in FIG. 9, as the male mold 10 and the female mold 20 are further joined together such that the mold cores 11 and 21 move out of the slide holes 17 and 27. In light of the mold cavity edges 13 and 23 of the mold cavities 12 and 22 being respectively smaller than the slide holes 17 and 27, the air in the air sac body 34 is compressed to result in an increase in the air pressure, thereby causing the air sac body 34 to take shape in the mold cavities 12 and 22. Upon completion of the process of cooling the molds 10 and 20 by the cooling water pipes 18 and 28, the molding tool is opened to remove therefrom the air sac body 34. As shown in FIG. 10, the air sac body 34 has a fringe line A and a fringe line B. The fringe line A is the fringe lone of the slide hole of the prepress board, whereas the fringe lone B is the fringe line of the mold cavity edge. The air sac body 34 is dressed to become an end product which contains gas and is devoid of the seal mark, as illustrated in FIG. 11.

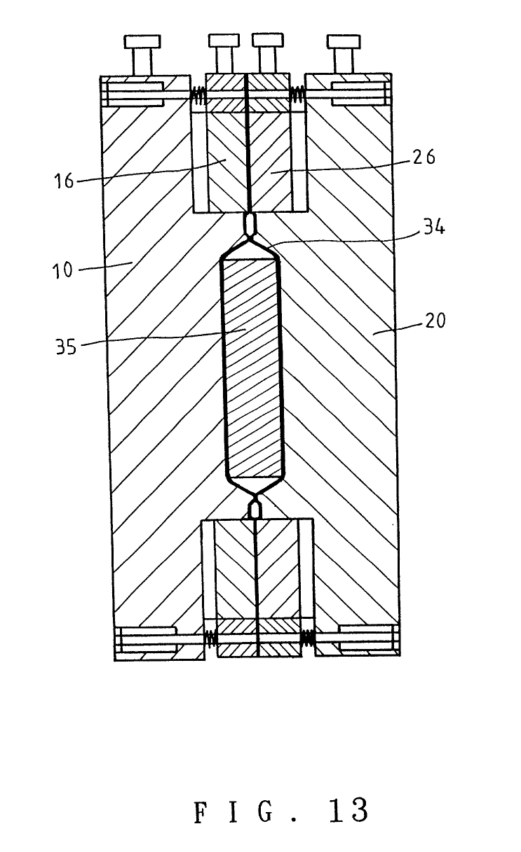

As illustrated in FIGS. 12 and 13, the cylindrical body forming machine is provided with an inserting device 36 by which a filling 35 is inserted into the cylindrical PU body 31 prior to the feeding of the cylindrical PU body 31 into the molding tool of the present invention. The inserting device 36 is withdrawn as soon as the male mold 10 and the female mold 20 are joined together. As a result, the air sac body 34 contains the filling 35.

The present invention described above is to regarded in all respects as being illustrative and nonrestrictive. Accordingly, the present invention may be embodied in other specific forms without deviating from the spirit thereof. For example, the male mold and the female mold of the device of the present invention may be provided with a plurality of mold cores to facilitate the making of a plurality of air sac bodies in one process. The present invention is therefore to be limited only by the scopes of the following claims.

What is claimed is:

1. A device for making an air sac, said device comprising;
a male mold provided with at least one mold core, said mold core being provided with a mold cavity, said male mold further provided with a male prepress board fastened movably therewith, said male prepress board being provided with at least one slide hole corresponding in location and number to said mold core of said male mold; and
a female mold provided with at least one mold core, said mold core being provided with a mold cavity, said female mold further provided with a female prepress board fastened movably therewith, said female prepress board being provided with at least one slide hole corresponding in location and number to said mold core of said female mold.

2. The device as defined in claim 1, wherein said male prepress board is movably fastened with said male mold by a plurality of fastening rods, and springs fitted over said fastening rods; wherein said female prepress board is movable fastened with said female mold by a plurality of fastening rods, and springs fitted over said fastening rods.

3. The device as defined in claim 1, wherein said mold cavity of said mold core of said male mold is provided with a mold cavity edge so as to make volume of said mold cavity smaller than said slide hole of said male prepress board at the time when said male mold is joined with said female mold; wherein said mold cavity of said mold core of said female mold is provided with a mold cavity edge so as to make volume of said mold cavity smaller than said slide hole of said female prepress board at such time when said female mold is joined with said male mold.

4. The device as defined in claim 1, wherein said male mold, said male prepress board, said female mold, and said female prepress board are provided with a plurality of water pipes to facilitate the cooling of said device.

5. A method for making an air sac by using the device as defined in claim 1, said method comprising the steps of:
(a) feeding at least one cylindrical polyurethane body into the device;
(b) closing the device such that the cylindrical polyurethane body is flattened out by the male prepress board and the female prepress board, and that a gas-containing air sac body is formed in the slide holes of the prepress boards;
(c) closing further the device such that the mold cores of the male mold and the female mold are moved out of the slide holes of the prepress boards, and that the air sac body is pressed against by the mold cavity edges;
(d) forming an air sac in the mold cavities;
(e) cooling the device; and
(f) opening the device to remove therefrom the air sac.

6. The method as defined in claim 5, wherein the step (a) comprised a process by which a filling is inserted into the cylindrical polyurethane body.
